(19) United States
(12) Patent Application Publication
(10) Pub. No.: US 2018/0103634 A1
(43) Pub. Date: Apr. 19, 2018

(54) ATTENUATION OF PHYTOTOXICITY OF MULTISITE FUNGICIDES BY HIGH-MOLECULAR-WEIGHT DISPERSANTS

(71) Applicant: BASF SE, Ludwigshafen am Rhein (DE)

(72) Inventors: Bastian Marten Noller, Otterstadt (DE); Maria Angelica Quintero Palomar, Mannheim (DE); Nadege Boudet, Hirschberg (DE); Ana Escribano Cuesta, Mannheim (DE)

(21) Appl. No.: 15/562,031

(22) PCT Filed: Apr. 8, 2016
(86) PCT No.: PCT/EP2016/057707

§ 371 Date: Sep. 27, 2017

(30) Foreign Application Priority Data
Apr. 16, 2015 (EP) 15163877.2

(51) Int. Cl. A01N 25/14; A01N 25/32; A01N 25/30; A01N 43/32; A01N 43/90

(52) U.S. Cl. CPC A01N 25/14; A01N 25/32; A01N 43/90; A01N 43/32; A01N 25/30

(57) ABSTRACT

Provided herein is an agrochemical composition containing a solid multisite fungicide and a dispersing agent, wherein the dispersing agent has a mass average molar mass greater than 5,000 g/mol and is selected from lignin sulfonates and poly(meth)acrylates. Also provided herein is a method of preparing the agrochemical composition comprising the contacting of the solid multisite fungicide and the dispersing agent. Further, provided herein is a method of controlling phytopathogenic fungi, wherein the agrochemical composition is allowed to act on the respective fungi, their environment or the crop plants to be protected from the respective pest, on the soil and/or on undesired plants and/or on the crop plants and/or on their environment. Additionally, provided herein is a use of the dispersing agent for attenuating the phytotoxicity of multisite fungicides; and seed containing said agrochemical composition.

The present invention relates to an agrochemical composition containing a solid multisite fungicide and a dispersing agent, wherein the dispersing agent has a mass average molar mass greater than 5,000 g/mol and is selected from lignin sulfonates and poly(meth)acrylates. The invention also relates to a method of preparing the agrochemical composition comprising the contacting of the solid multisite fungicide and the dispersing agent. Furthermore the invention relates to a method of controlling phytopathogenic fungi, wherein the agrochemical composition is allowed to act on the respective fungi, their environment or the crop plants to be protected from the respective pest, on the soil and/or on undesired plants and/or on the crop plants and/or on their environment. Further subject matter are a use of the dispersing agent for attenuating the phytotoxicity of multisite fungicides; and seed containing said agrochemical composition. The present invention comprises combinations of preferred features and embodiments with other preferred features and embodiments.

Multisite fungicides are directed to a multitude of biochemical targets and are thus not prone to spark off resistance evolution. However, their unspecific mode of action makes them also quite phytotoxic and thus limits their agrochemical applications.

Object of the present invention was to attenuate the phytotoxicity of multisite fungicides in agrochemical formulations.

The object was achieved by an agrochemical composition containing a solid multisite fungicide and a dispersing agent, wherein the dispersing agent has a mass average molar mass greater than 5,000 g/mol and is selected from lignin sulfonates and poly(meth)acrylates.

Herein, the term agrochemical composition may refer to any type of agrochemical formulation, such as solid or liquid formulations. Examples for composition types are suspensions (e.g. SC, OD, FS), pastes, pastilles, wettable powders or dusts (e.g. WP, SP, WS, DP, DS), pressings (e.g. BR, TB, DT), granules (e.g. WG, SG, GR, FG, GG, MG). Further examples for compositions types are listed in the “Catalogue of pesticide formulation types and international coding system”, Technical Monograph No 2, 6th Ed. May 2008, CropLife International. Preferably, the agrochemical composition relates to suspensions, water-dispensable granules or wettable powders, more preferably to suspensions and water-dispersible granules. In one embodiment, the agrochemical composition relates to water-dispersible granules. In another embodiment, the agrochemical composition relates to suspensions, preferably aqueous suspensions.

The agrochemical composition contains a multisite fungicide, which relates to at least one fungicide that detrimentally affects more than one biochemical target or process, such as a specific protein, a signaling or metabolic pathway. A general description and definition of multisite fungicides can be found in Fungicide Resistance: The Assessment of Risk, Fungicide Resistance Action Committee, Monograph No. 2, 2^{nd} revised edition (2007), Belgium.

The skilled worker is familiar with such multisite fungicides, which can be found, for example, in the Pesticide Manual, 16th Ed. (2013), The British Crop Protection Council, London. Suitable multisite fungicides are from the class of dithiins, inorganic fungicides, dithiocarbamates, phthalimides, chloronitriles, sulphamides, guanidines, triazines, and quinones. Preferred multisite fungicides are selected from dithiines, sulphamides, phthalimides, chloronitriles and triazines, more preferably from dithiins and chlorothalonil and especially preferably from dithiins.

Mixtures of pesticides of two or more of the abovementioned classes may also be used.

Examples of multisite fungicides are chlorothalonil, captafol, captan, sulfur, copper, chlorothalonil, folpet, ferbam, mancozeb, maneb, metiram, propineb, thiram, zineb, ziram, dichlofluanid, tolylfluanid, dodine, guazatine, iminoctadine, anilazine, and dithiin compounds I

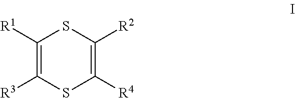

wherein at least one of the substituents R¹, R², R³ and R⁴ is selected from electron-withdrawing groups. Preferably, the multisite fungicide is a compound of formula I, wherein at least one of the substituents R¹, R², R³ and R⁴ is selected from electron-withdrawing groups.

Examples of electron-withdrawing groups in the indicated positions are halogen, NO₂, CN, carbonyl, carboxylate, carboxamide, sulfoxide, sulfone, sulfonate, sulfonamide, amine (primary, secondary, and tertiary), and hydroxyl.

Typically, the multisite fungicide is a compound I, wherein the substitutents have the following meaning:
R¹, R², R³, and R⁴ are independently halogen, NO₂, CN, S(O)ₘ(R⁵), N(R⁶)₂, S(O)ₘN(R⁵)₂, COR⁶, CON(R⁵)₂, C(NO₂)(R⁶)₂, C(CN)(R⁶)₂, C(NC)(R⁶)₂, C(S(O)ₘR⁵)R⁶, C₁-C₁₀-haloalkyl, a 3-10-membered carbocycle, or a 3-10-membered heterocycle; and/or
   R¹ and R³, and/or R² and R⁴ form together with the dithiin ring to which they are bonded a saturated, partially saturated, or fully unsaturated 5-10-membered carbocycle, or a 5-10-membered heterocycle;
   which carbocycle or heterocycle is unsubstituted, or substituted with one or more, same or different substituents R⁷; and
   in which carbocycle or heterocycle none, one, or more groups, or atoms CH₂, CH, or C are replaced by C(O); and
   wherein the heterocycle comprises one or more, same or different heteroatoms O, N(O)ₙ, and S(O)ₘ, wherein said N and S atoms, independently from one another, are oxidized or not oxidized;
R⁵ is independently H, C₁-C₁₀-alkyl, C₂-C₁₀-alkenyl, C₂-C₁₀-alkynyl, C₁-C₁₀-haloalkyl, C₁-C₁₀-cyanoalkyl, C₁-C₁₀-nitroalkyl, a 3-10-membered carbocycle, or a 3-10-membered-heterocycle;
R⁶ is independently H, C₁-C₁₀-alkyl, C₂-C₁₀-alkenyl, C₂-C₁₀-alkynyl, C₁-C₁₀-haloalkyl, C₁-C₁₀-cyanoalkyl, C₁-C₁₀-nitroalkyl, C₁-C₁₀-alkoxy, C₁-C₁₀-alkylthio, a 3-10-membered carbocycle, or a 3-10-membered heterocycle;
R⁷ is C₁-C₁₀-alkyl, C₂-C₁₀-alkenyl, C₂-C₁₀-alkynyl, C₁-C₁₀-haloalkyl, C₁-C₁₀-cyanoalkyl, halogen, NO₂, CN, S(O)ₘ(R⁵), N(R⁶)₂, N(R⁶)OR⁵, N(R⁵)SR⁵, S(O)ₘN(R⁶)₂, COR⁵, COOR⁵, CON(R⁶)₂, C(NO₂)(R⁶)₂, C(CN)(R⁶)₂, C(NC)(R⁶)₂, or C(S(O)ₘR⁵)R⁵, a 3-10-membered carbocycle, or a 3-10-membered heterocycle;
   in which carbocycle or heterocycle none, one, or more groups, or atoms CH₂, CH, or C are replaced by C(O); and
   wherein the heterocycle comprises one or more, same or different heteroatoms O, N(O)ₙ, and S(O)ₘ, wherein said N and S atoms, independently from one another, are oxidized or not oxidized; and
   the index m is 0, 1, or 2;
   the index n is 0, or 1.

Compounds of formula I are known. They can be inter alia be prepared as described in U.S. Pat. No. 3,364,229, U.S. Pat. No. 3,400,134, WO2011/128301, WO95/29181, U.S. Pat. No. 4,150,130, WO2010/043319, U.S. Pat. No. 3,663,543, U.S. Pat. No. 3,265,565, U.S. Pat. No. 4,004,018, DE-B 1060655, JP-B 48-11020, JP-A 50-40736, WO2014/086601, and JP-B52-31407. Others are commercially available, such as dithianone. In case the individual compound is not described in the cited publications, it may be prepared from a described compound by methods of derivatisation known to the skilled person.

The organic moieties mentioned in the definition of the variables R¹ to R⁷ are—like the term halogen—collective terms for individual enumerations of the individual group members. The term halogen denotes in each case fluorine, chlorine, bromine or iodine. All hydrocarbon chains, i.e. all alkyl, can be straight-chain or branched, the prefix Cₙ-Cₘ denoting in each case the possible number of carbon atoms in the group.
The term “alkoxy” as used herein denotes in each case a straight-chain or branched alkyl group which is bonded via an oxygen atom and has usually from 1 to 10 carbon atoms, frequently from 1 to 6 carbon atoms, preferably 1 to 4 carbon atoms. Examples of an alkoxy group are methoxy, ethoxy, n-propoxy, iso-propoxy, n-butyloxy, 2-butyloxy, iso-butyloxy, tert.-butyloxy, and the like.
The term “alkylthio “(alkylsulfanyl: alkyl-S—)” as used herein refers to a straight-chain or branched saturated alkyl group having 1 to 10 carbon atoms, preferably 1 to 4 carbon atoms (═C₁-C₄-alkylthio), more preferably 1 to 3 carbon atoms, which is attached via a sulfur atom. Examples include methylthio, ethylthio, propylthio, isopropylthio, and n-butylthio.
The term “haloalkyl” as used herein and in the haloalkyl moieties of haloalkylcarbonyl, haloalkoxycarbonyl, haloalkylthio, haloalkylsulfonyl, haloalkylsulfinyl, haloalkoxy and haloalkoxyalkyl, denotes in each case a straight-chain or branched alkyl group having usually from 1 to 10 carbon atoms, frequently from 1 to 6 carbon atoms, preferably from 1 to 4 carbon atoms, wherein the hydrogen atoms of this group are partially or totally replaced with halogen atoms. Preferred haloalkyl moieties are selected from C₁-C₄-haloalkyl, more preferably from C₁-C₃-haloalkyl or C₁-C₂-haloalkyl, in particular from C₁-C₂-fluoroalkyl such as fluoromethyl, difluoromethyl, trifluoromethyl, 1-fluoroethyl, 2-fluoroethyl, 2,2-difluoroethyl, 2,2,2-trifluoroethyl, pentafluoroethyl, and the like.
The term “carbocycle” includes in general mono-cyclic, and bicyclic saturated, partially unsaturated, or unsaturated rings. Preferably, the term “carbocycle” covers cycloalkyl and cycloalkenyl groups as defined above, for example cyclopropane, cyclobutane, cyclopentane and cyclohexane rings. Typical carbocycles are cyclopropyl, cyclobutyl, cyclopropyl, cyclohexyl, cyclooctyl, phenyl, cyclopropylene, cyclobutylene, cyclopentadien, cyclohexene, cyclooctadien, cyclooctatetraen, phenyl, naphthalene, tetraline, indane, anthracene, and phenanthrene.
The term “heterocycle” includes mono- and bicyclic heterocycles and contains 1, 2, 3, 4 or 5, preferably 1, 2 or 3 heteroatoms selected from N, O and S as ring members, wherein S-atoms as ring members may be present as S, SO or SO₂, and N-atoms as ring members may be present as N, or NO. The term heterocycle further relates to saturated, partially unsaturated, or unsaturated heterocycles. Examples of saturated and partially saturated heterocycles, such as oxiranyl, oxetanyl, thietanyl, thietanyl-S-oxid (S-oxothietanyl), thietanyl-S-dioxid (Sdioxothiethanyl), pyrrolidinyl, pyrrolinyl, pyrazolinyl, tetrahydrofuranyl, dihydrofuranyl, 1,3-dioxolanyl, thiolanyl, S-oxothiolanyl, S-dioxothiolanyl, dihydrothienyl, S-oxodihydrothienyl, Sdioxodihydrothienyl, oxazolidinyl, oxazolinyl, thiazolinyl, oxathiolanyl, piperidinyl, piperazinyl, pyranyl, dihydropyranyl, tetrahydropyranyl, 1,3- and 1,4-dioxanyl, thiopyranyl, S.oxothiopyranyl, S-dioxothiopyranyl, dihydrothiopyranyl, S-oxodihydrothiopyranyl, S-dioxodihydrothiopyranyl, tetrahydrothiopyranyl, S-oxotetrahydrothiopyranyl, S-dioxotetrahydrothiopyranyl, morpholinyl, thiomorpholinyl, S-oxothiomorpholinyl, S-dioxothiomorpholinyl, thiazinyl and the like. Examples for heterocycles containing 1 or 2 carbonyl groups as ring members comprise pyrrolidin-2-onyl, pyrrolidin-2,5-dionyl, imidazolidin-2-onyl, oxazolidin-2-onyl, thiazolidin-2-onyl and the like.
Examples of fully unsaturated heterocycles include pyridyl, i.e. 2-, 3-, or 4-pyridyl, pyrimidinyl, i.e. 2-, 4- or 5-pyrimidinyl, pyrazinyl, pyridazinyl, i.e. 3- or 4-pyridazinyl, thienyl, i.e. 2- or 3-thienyl, furyl, i.e. 2- or 3-furyl, pyrrolyl, i.e. 2- or 3-pyrrolyl, oxazolyl, i.e. 2-, 3- or 5-oxazolyl, isoxazolyl, i.e. 3-, 4- or 5-isoxazolyl, thiazolyl, i.e. 2-, 3- or 5-thiazolyl, isothiazolyl, i.e. 3-, 4- or 5-isothiazolyl, pyrazolyl, i.e. 1-, 3-, 4- or 5-pyrazolyl, i.e. 1-, 2-, 4- or 5-imidazolyl, oxadiazolyl, e.g. 2- or 5-[1,3,4]oxadiazolyl, 4- or 5-(1,2,3-oxadiazol)yl, 3- or 5-(1,2,4-oxadiazol)yl, 2- or 5-(1,3,4-thiadiazol)yl, thiadiazolyl, e.g. 2- or 5-(1,3,4-thiadiazol)yl, 4- or 5-(1,2,3-thiadiazol)yl, 3- or 5-(1,2,4-thiadiazol)yl, triazolyl, e.g. 1H-, 2H- or 3H-1,2,3-triazol-4-yl, 2H-triazol-3-yl, 1H-, 2H-, or 4H-1,2,4-triazolyl and tetrazolyl, i.e. 1H- or 2H-tetrazolyl. The term heterocycle also includes bicyclic 8 to 10-membered heteroaromatic radicals comprising as ring members 1, 2 or 3 heteroatoms selected from N, O and S, wherein a 5- or 6-membered heteroaromatic ring is fused to a phenyl ring or to a 5- or 6-membered heteroaromatic radical. Examples of a 5- or 6-membered heteroaromatic ring fused to a phenyl ring or to a 5- or 6-membered heteroaromatic radical include benzofuranyl, benzothienyl, indolyl, indazolyl, benzimidazolyl, benzoxathiazolyl, benzoxadiazolyl, benzothiadiazolyl, benzoxazinyl, chinolinyl, isochinolinyl, purinyl, 1,8-naphthyridyl, pteridyl, pyrido[3,2-d]pyrimidyl or pyridoimidazolyl and the like. These fused heterocycles may be bonded to the remainder of the molecule via any ring atom of 5- or 6-membered heteroaromatic ring or via a carbon atom of the fused phenyl moiety.

Stereoisomers, salts, tautomers or N-oxides, or polymorphic crystalline forms, co-crystals or solvates of compounds or stereoisomers, salts, tautomers or N-oxides of the aforementioned compounds are included in the meaning compounds I.

In one embodiment, the multisite fungicide is a compound of compounds I, wherein
R¹, R², R³, and R⁴ are independently halogen, NO₂, or CN; and/or
R¹ and R³, and/or R² and R⁴ form together with the dithiin ring to which they are bonded a saturated, partially saturated, or fully unsaturated 5-10-membered carbocycle, or a 5-10-membered heterocycle which carbocycle or heterocycle is unsubstituted, or substituted with one or more, same or different substituents R⁷; and
   in which carbocycle or heterocycle none, one, or more groups, or atoms CH₂, CH, or C are replaced by C(O); and
   wherein the heterocycle and comprises one or more, same or different heteroatoms O, N(O)ₙ, and S(O)ₘ, wherein said N and S atoms, independently from one another, are oxidized or not oxidized; and
R⁷ is C₁-C₃-alkyl, C₂-C₄-alkenyl, C₂-C₄-alkynyl, C₁-C₃-haloalkyl, C₁-C₃-cyanoalkyl, halogen, NO₂, CN, S(O)ₘ(R⁵), N(R⁶)₂, N(R⁶)OR⁵, N(R⁵)SR⁵, S(O)ₘN(R⁶)₂, COR⁵, COOR⁵, CON(R⁶)₂, C(NO₂)(R⁶)₂, C(CN)(R⁶)₂, C(NC)(R⁶)₂, or C(S(O)ₘR⁵)R⁵, a 3-10-membered carbocycle, or a 3-10-membered heterocycle;
   in which carbocycle or heterocycle none, one, or more groups, or atoms CH₂, CH, or C are replaced by C(O); and
   wherein the heterocycle comprises one or more, same or different heteroatoms O, N(O)ₙ, and S(O)ₘ, wherein said N and S atoms, independently from one another, are oxidized or not oxidized; and
      wherein the other substituents and inices have a meaning as given above.

In another embodiment, the multisite fungicide is a compound of compounds I, wherein
R¹, R², R³, and R⁴ are independently CN, NO₂; and/or
R¹ and R³, and/or R² and R⁴ form together with the dithiin ring to which they are bonded a saturated, partially saturated, or fully unsaturated 5-10-membered carbocycle, or a 5-10-membered heterocycle which carbocycle or heterocycle is unsubstituted, or substituted with one or more, same or different substituents R⁷; and
   in which carbocycle or heterocycle none, one, or more groups, or atoms CH₂, CH, or C are replaced by C(O); and
   wherein the heterocycle and comprises one or more, same or different heteroatoms O, N(O)ₙ, and S(O)ₘ, wherein said N and S atoms, independently from one another, are oxidized or not oxidized; and
R⁷ is C₁-C₃-alkyl, halogen, NO₂, or CN;
   and wherein the other substituents and indices have a meaning as given above.

In another embodiment, the multisite fungicide is a compound of formula (I), wherein
R¹, R², R³, and R⁴ are independently CN; and/or
R¹ and R³, and/or R² and R⁴ form together with the dithiin ring to which they are bonded a saturated, partially saturated, or fully unsaturated 5-10-membered carbocycle, or a 5-10-membered heterocycle which carbocycle or heterocycle is unsubstituted, or substituted with one or more, same or different substituents R⁷; and
   in which carbocycle or heterocycle none, one, or more groups, or atoms CH₂, CH, or C are replaced by C(O); and
   wherein the heterocycle and comprises one or more, same or different heteroatoms O, N(O)ₙ, and S(O)ₘ, wherein said N and S atoms, independently from one another, are oxidized or not oxidized; and
R⁷ is C₁-C₃-alkyl, or CN.

In one example, the multisite fungicide is selected from dithianone, chlorthalonil, and N,N′-dimethyl-1,4-dithiin-2,3,5,6-tetracarboxylic acid diimide. In another example, the multisite fungicide is selected from dithianone, chlorthalonil, N,N′-dimethyl-1,4-dithiin-2,3,5,6-tetracarboxylic acid diimide, and 11-ethyl-10,12-dioxo-2,5,8-trithia-4,11-diazatricyclo[7.3.0.0^{3,7}]dodeca-1 (9),3,6-triene-6-carbonitrile (as prepared in WO2014/086601).

In a more preferred example, the multisite fungicide is dithianone. In another embodiment, the multisite fungicide is dithianone or N′-dimethyl-1,4-dithiin-2,3,5,6-tetracarboxylic acid diimide. In yet another embodiment, the multisite fungicide is chlorthalonil. In another embodiment, the multisite fungicide is 11-ethyl-10,12-dioxo-2,5,8-trithia-4,11-diazatricyclo[7.3.0.0^{3,7}]dodeca-1(9),3,6-triene-6-carbonitrile.

The multisite fungicide is solid at 20° C. The melting temperature of the multisite fungicide may be at least 40° C., preferably at least 50° C. and most preferably at least 60° C.

The multisite fungicide is typically water-insoluble. The term water-insoluble relates to a water-solubility of below 10 g/l, preferably below 1 g/l, and most preferably below 0.1 g/l. The water solubility is usually measured at pH 7.0.

Typically, the multisite fungicide is phytotoxic, referring to detrimental effects on desired plants or their seeds and propagation material, such as on crop plants or ornamental plants. Examples of detrimental effects are wilting, restrained growth, reduced production of biomass, leaf spots, necrotic lesions, root rot, blight, canker, reduced germination, withering, decreased quantity or quality of crops.

The applied amount from which on the multisite fungicide develops detrimental effects on desired plants and thus becomes phytotoxic may be from 20 kg/ha, preferably from 10 kg/ha, more preferably from 5 kg/ha and most preferably from 1 kg/ha of the multisite fungicide per applied area, depending on the plants and formulation type.

In another embodiment, the applied amount from which on the multisite fungicide develops detrimental effects on desired plants and thus becomes phytotoxic may be from 0.01 kg/ha, preferably from 0.1 kg/ha, more preferably from 0.5 kg/ha and most preferably from 1 kg/ha of the multisite fungicide per applied area, depending on the plants and formulation type.

The agrochemical composition may contain from at least 1 wt %, preferably from at least 5 wt % and most preferably from at least 10 wt % of the multisite fungicide with regard to the total weight of the agrochemical composition. The agrochemical composition may contain up to 99 wt %, preferably up to 95 wt % and most preferably up to 90 wt % of the multisite fungicide with regard to the total weight of the agrochemical composition.

The agrochemical composition contains a dispersing agent. The dispersing agent may be of natural origin with subsequent chemical modification (e.g. lignin sulfonate) or a synthetic compound derived by a polymerization reaction.

Dispersing agents are selected from lignin sulfonates and poly(meth)acrylates, preferably lignin sulfonates.

Preferably, the poly(meth)acrylate is a alkoxylated poly(meth)acrylate graft polymer, more preferably an ethoxylated and propoxylated poly(meth)acrylate graft polymer, most preferably an ethoxylated poly(meth)acrylate graft polymer. Typically, the poly(meth)acrylate comprises monomers selected from (meth)acrylate, C₁-C₃₀-alkylesters of (meth)acrylate, C₅-C₁₂-carbocyclylester of (meth)acrylate, C₁-C₃₀-alkyl-C₅-C₁₂-carbocyclylesters of (meth)acrylate, polyalkylene oxide esters of (meth)acrylate, C₁-C₆-alkyl-polyalkylene oxide esters of (meth)acrylate, maleic acid, itaconic acid, 2-acrylamido-2-methylpropane sulfonic acid.

In one embodiment, the poly(meth)acrylate comprises monomers selected from (meth)acrylate, C₁-C₃₀-alkylesters of (meth)acrylate, polyalkylene oxide esters of (meth)acrylate, and C₁-C₆-alkyl-polyalkylene oxide esters of (meth)acrylate.

In another embodiment, the poly(meth)acrylate comprises monomers selected from (meth)acrylate, C₁-C₃₀-alkylesters of (meth)acrylate, polyethylene oxide esters of (meth)acrylate, and C₁-C₆-alkyl-polyalkylene oxide esters of (meth)acrylate.

In another embodiment, the poly(meth)acrylate comprises monomers selected from (meth)acrylate, C6-C₂₀-alkylesters of (meth)acrylate, polyethylene oxide esters of (meth)acrylate, and C₁-C₃-alkyl-polyalkylene oxide esters of (meth)acrylate.

The poly(meth)acrylate may comprise up to 10 wt % of other monomers, preferably up to 1 wt % of other monomers, and in particular no other monomers with respect to the total mass of the polymer.

Other monomers include (meth)acrylamide, vinylacetate, vinylpropionate, vinylpyridine, styrene, methyl styrene, vinylchloride, N-vinylpyrolidone, methacrylnitrile, N-methylol (meth)acrylamide, dimethylaminoethyl (meth)acrylamide, 2-hydroxyethyl(meth)acrylate, and divalent- and multivalent ethylenically unsaturated monomers. Divalent- and multivalent ethylenically unsaturated monomers are usually polyesters of polyols with (meth)acrylic acid, polyallyl- and polyvinylethers of such polyols. Examples of divalent- and multivalent ethylenically unsaturated monomers are trimethylolpropane tri(meth)acrylate, pentaerythritol triallylether, pentaerythritol tetraallylether, pentaerythritol tri(meth)acrylat, and pentaerythritol tetra(meth)acrylat.

The mentioned dispersant classes and their production are all known to the skilled person and can be found in standard text books on polymers.

As an example, lignin sulfonate is obtained as a by-product of paper manufacturing using the sulfite process. In this process, wood that has been reduced to wood chips is heated for about 7 to 15 hours in the presence of calcium hydrogen sulfite liquor and under pressure (for example 5 to 7 bar) and then the ligninsulfonic acid is removed from the lignocellulose in the form of calcium lignin sulfonate in a washing and precipitation process. Alternatively, SO₂-gas can be introduced in the presence of an inorganic base. Liquors of magnesium, sodium or ammonium sulfite can also be used instead of calcium hydrogen sulfite, and these produce the corresponding magnesium, sodium and ammonium salts of lignin-sulfonic acid. When the washing liquor is evaporated, usually powdery lignin sulfonates remain.

Poly(meth)-acrylates can be obtained by solution polymerization. The poly(meth)acrylate is preferably obtainable by free-radical polymerization of the monomers either (i) in a solvent mixture composed of water and at least one organic solvent having a boiling point<140° C. or (ii) in one or more pure alcohols. The typical processes of free or controlled, preferably free, radical polymerization may be used, the reaction mixture comprising at least one initiator. The solvent mixture is preferably selected such that the monomers and also the copolymer formed are soluble. Soluble here, in the sense of the invention, encompasses not only a true solution but also a dispersion which is so finely divided that there is no clouding produced. The polymerization may be carried out as a batch reaction, in a semibatch procedure or in a continuous procedure. The polymerization is usually carried out in solution.

The reaction times are situated generally in the range between 1 and 48 h, preferably in the range from 2 to 24 h, and with more particular preference in the range from 4 to 24 h. The temperature range within which the reaction can be carried out extends generally from 20 to 200° C., preferably from 30 to 120° C., and with more particular preference from 40 to 90° C.

As initiators for the free-radical polymerization, typical radical-forming substances are used. The initiator is selected preferably from the group of the azo compounds, the peroxide compounds or the hydroperoxide compounds. Examples include acetyl peroxide, benzoyl peroxide, lauroyl peroxide, tert-butyl peroxyisobutyrate, caproyl peroxide, cumene hydroperoxide, azobis(isobutyronitrile), 2,2-azobis(2-methylbutyronitrile), 2,2′-azobis(2-methylpropionamidine) dihydrochloride, and 2,2′-azobis[2-(2-imidazolin-2-yl)propane]dihydrochloride. It will be appreciated that initiator mixtures can also be used.

The polydispersity and the molecular weight of the free-radical polymer may be adjusted if desired through the variation of the initiator/monomer ratio, the feed time of the substrates, especially the feed time of the initiator solution in comparison to the feed time of the monomer solution(s), through variation in the alcohol content, more particularly isopropanol content, of the solvent mixture, and through the polymerization concentration. If a short initiator feed and/or a high isopropanol content (regulator or chain-transfer agent) in the solvent mixture is selected, and/or if a low polymerization concentration (high regulator/monomer ratio) is selected, the resulting polydispersities are generally relatively low. Through the use of additional regulators or chain-transfer agents from the group of the mecaptans, such as mercaptoethanol, thio-glycerol or 1-dodecyl mercaptan, it is possible, if desired, to achieve a further reduction in the polydispersity of the copolymer. The molar masses Mw and Mn and also the polydispersity are determined by means of size exclusion chromatography. Calibrating agents that can be used are commercial polystyrene or poly(ethylene oxide) calibration sets.

The copolymer may if desired be isolated and worked up. Workup is accomplished in a known way familiar to the skilled person, as for example by a prior filtration step. This makes it possible optionally to remove the 2-amino-2-methylpropanesulfonic acid byproduct. If desired, the solvent may subsequently be removed. Examples of typical methods of removing the solvent include spray drying, evaporation at reduced pressure, freeze drying, and evaporation under atmospheric pressure with optionally elevated temperature. The methods suitable for drying further include drying in a fluidized bed dryer. Another option is to use the copolymer solution obtainable by the process without workup.

The dispersing agent has usually a water-solubility at 25° C. and pH 7 of at least 10 g/l, preferably at least 50 g/l and most preferably at least 100 g/l.

Usually, the dispersing agent is solid at room temperature (20° C.). The melting temperature of the dispersing agent is usually above 40° C., preferably above 60° C. and most preferably above 80° C.

Depending on the chemical nature of the dispersing agent, the term melting temperature refers to dispersing agents with a stochastic distribution of polymer chains and also to biopolymers with a natural, or process-generated mixture of different chemical substances. Melting may hence occur over a big temperature range, which may be referred to as glass transition temperature.

The mass average molar mass of the dispersing agent is above 5,000 g/mol, preferably above 15,000 g/mol, more preferably above 20,000 g/mol. The mass average molar mass of the dispersing agent may be below 500,000 g/mol, preferably below 200,000 and more preferably below 100,000 g/mol. The mass average molar mass of the dispersing agent may be below 2,000,000 g/mol, preferably below 1,500,000 g/mol.

The mass average molar mass can be determined by static light scattering using a Malvern Zetasizer Nano S instrument and the Mie scattering theory. Herein, the sample is diluted in water inserted into a polyethylene cuvette. A light beam produced by a laser is diffracted by Rayleigh diffraction by the particles. The primary readout information provided by static light scattering is the angular dependence of the time average light scattering intensity for at least one angle. The Debye-Plot can then be used to calculate the mass average molar mass from the measured data. A detailed description can, for example, be found in Light Scattering—Principles and Development, Wyn Brown (1996), Oxford Univ Pr.

The agrochemical composition usually leads to a very low penetration of the multisite fungicide through the plant cuticula into the plant leaf of a treated plant, if any penetration at all can be determined. The penetration of the multisite fungicide through the plant cuticula into the plant leaf can be measured by the following Penetration Test:

Three 1 μl droplets containing the agrochemical composition are applied onto a corn leaf and allowed to dry for one hour. Three replica for each agrochemical composition are conducted on three different leaves. Corn plants are then cultivated for 7 days at 80% relative humidity in a light-climate chamber (Filtotron SGC 120, Weiss Technik UK) at 20/16° C. in 16/8 hours day-and-night-cycles.

After different time intervals, the treated areas of the plant are washed with a solution of 50 wt % of methanol in water (Surface Fraction). The leaves are then homogenized in methanol and the debris of the leaves is separated by centrifugation. The supernatant is used for further analysis (Penetration Fraction).

The amount of multisite fungicide in the Surface Fraction and in the Penetration fraction is quantitatively determined by HPLC-MS/MS.

Typically, the ratio of the amount of the multisite fungicide in the Surface Fraction to the amount in the Penetration Fraction (which ratio is hereinafter referred to as Surface Retention) after one day of cultivation is at least 90:10, preferably at least 95:5, more preferably from 99:1. Usually, the Surface Retention after 7 days of cultivation is at least 80:20, preferably at least 85:15, more preferably from 90:10.

The agrochemical composition may contain at least 1 wt % of the dispersing agent, preferably at least 2 wt % and most preferably at least 5 wt % of the dispersing agent. The agrochemical composition may contain up to 40 wt %, preferably up to 20 wt % and most preferably up to 10 wt % of the dispersing agent, each time referring to the total mass of the agrochemical composition.

In one example, the agrochemical composition contains from 1 to 99 wt % of the solid multisite fungicide and from 1 to 60 wt % of the dispersing agent.

In another example, the agrochemical composition contains from 5 to 95 wt % of the solid multisite fungicide and from 2 to 40 wt % of the dispersing agent.

In yet another example, the agrochemical composition contains from 10 to 90 wt % of the solid multisite fungicide and from 5 to 20 wt % of the dispersing agent.

In yet another example, the agrochemical composition contains from 10 to 90 wt % of the solid multisite fungicide and from 5 to 15 wt % of the dispersing agent.

The agrochemical composition may contain a further pesticide in addition to the multisite fungicide. The term further pesticide refers to at least one active substance selected from the group of fungicides, insecticides, nematicides, herbicides, safeners, biopesticides and/or growth regulators. Preferred pesticides are fungicides, insecticides, herbicides and growth regulators. Especially preferred pesticides are insecticides. Mixtures of pesticides of two or more of the abovementioned classes may also be used. The skilled worker is familiar with such pesticides, which can be found, for example, in the Pesticide Manual, 16th Ed. (2013), The British Crop Protection Council, London. Suitable insecticides are insecticides from the class of the carbamates, organophosphates, organochlorine insecticides, phenylpyrazoles, pyrethroids, neonicotinoids, spinosins, avermectins, milbemycins, juvenile hormone analogs, alkyl halides, organotin compounds nereistoxin analogs, benzoylureas, diacylhydrazines, METI acarizides, and insecticides such as chloropicrin, pymetrozin, flonicamid, clofentezin, hexythiazox, etoxazole, diafenthiuron, propargite, tetradifon, chlorofenapyr, DNOC, buprofezine, cyromazine, amitraz, hydramethylnon, acequinocyl, fluacrypyrim, rotenone, or their derivatives. Suitable fungicides are fungicides from the classes of dinitroanilines, allylamines, anilinopyrimidines, antibiotics, aromatic hydrocarbons, benzenesulfonamides, benzimidazoles, benzisothiazoles, benzophenones, benzothiadiazoles, benzotriazines, benzyl carbamates, carbamates, carboxamides, carboxylic acid diamides, chloronitriles cyanoacetamide oximes, cyanoimidazoles, cyclopropanecarboxamides, dicarboximides, dihydrodioxazines, dinitrophenyl crotonates, dithiocarbamates, dithiolanes, ethylphosphonates, ethylaminothiazolecarboxamides, guanidines, hydroxy-(2-amino)pyrimidines, hydroxyanilides, imidazoles, imidazolinones, inorganic substances, isobenzofuranones, methoxyacrylates, methoxycarbamates, morpholines, N-phenylcarbamates, oxazolidinediones, oximinoacetates, oximinoacetamides, peptidylpyrimidine nucleosides, phenylacetamides, phenylamides, phenylpyrroles, phenylureas, phosphonates, phosphorothiolates, phthalamic acids, phthalimides, piperazines, piperidines, propionamides, pyridazinones, pyridines, pyridinylmethylbenzamides, pyrimidinamines, pyrimidines, pyrimidinonehydrazones, pyrroloquinolinones, quinazolinones, quinolines, quinones, sulfamides, sulfamoyltriazoles, thiazolecarboxamides, thiocarbamates, thiophanates, thiophenecarboxamides, toluamides, triphenyltin compounds, triazines, triazoles. Suitable herbicides are herbicides from the classes of the acetamides, amides, aryloxyphenoxypropionates, benzamides, benzofuran, benzoic acids, benzothiadiazinones, bipyridylium, carbamates, chloroacetamides, chlorocarboxylic acids, cyclohexanediones, dinitroanilines, dinitrophenol, diphenyl ether, glycines, imidazolinones, isoxazoles, isoxazolidinones, nitriles, N-phenylphthalimides, oxadiazoles, oxazolidinediones, oxyacetamides, phenoxycarboxylic acids, phenylcarbamates, phenylpyrazoles, phenylpyrazolines, phenylpyridazines, phosphinic acids, phosphoroamidates, phosphorodithioates, phthalamates, pyrazoles, pyridazinones, pyridines, pyridinecarboxylic acids, pyridinecarboxamides, pyrimidinediones, pyrimidinyl(thio)benzoates, quinolinecarboxylic acids, semicarbazones, sulfonylaminocarbonyltriazolinones, sulfonylureas, tetrazolinones, thiadiazoles, thiocarbamates, triazines, triazinones, triazoles, triazolinones, triazolocarboxamides, triazolopyrimidines, triketones, uracils, ureas.

Usually, the agrochemical composition comprises from 1 to 90 wt %, preferably from 5 to 80 wt %, especially preferably from 10 to 50 wt % of the further pesticide with regard to the total weight of the agrochemical composition.

The further pesticide may be present in particulate or dissolved form. In case that the further pesticide is present in particulate form, the melting temperature of the further pesticide may be at least 35° C., preferably at least 45° C. and most preferably at least 55° C.

The agrochemical composition usually comprises less than 3 wt %, preferably less than 1 wt % and in particular less than 0.1 wt % of an organic solvent. In another form the agrochemical composition is essentially free of an organic solvent. Examples for organic solvents are water-insoluble solvents and water-soluble solvents. The water-insoluble solvent may be soluble in water at 20° C. up to 50 g/l, preferably up to 20 g/l, and in particular up to 5 g/l. The water-soluble solvent may be soluble in water at 20° C. more than 50 g/l, preferably more than 100 g/l.

The agrochemical composition may comprise less than 3 wt %, preferably less than 1 wt % and in particular less than 0.1 wt % of the water-insoluble solvent. In another form the agrochemical composition is essentially free of a water-insoluble solvent.

Examples of water-insoluble solvents are hydrocarbon solvents such a an aliphatic, cyclic and aromatic hydrocarbons (e. g. toluene, xylene, paraffin, tetrahydronaphthalene, alkylated naphthalenes or their non-ionic derivatives, mineral oil fractions of medium to high boiling point (such as kerosene, diesel oil, coal tar oils)).

Other examples of water-insoluble solvents are ketones, such as 2-heptanone, cyclohexanone, and acetophenone.

Usually, the agrochemical composition comprises less than 3% by weight, preferably less than 1% by weight, especially preferably less than 0.1%, and in particular less than 0.01% by weight of the water-soluble solvent. In one form the agrochemical composition is essentially free of a water-soluble solvent. Examples of water soluble solvents are dimethyl sulfoxide (DMSO), methanol, acetonitrile, or N-methyl pyrrolidone.

The term organic solvent as used herein is specifically not meant to relate to ethylene glycol, propylene glycol or butylene glycol and glycerol.

The agrochemical composition usually comprises less than 3 wt %, preferably less than 1 wt % and in particular less than 0.1 wt % of surfactants with a mass average molar mass up to 5,000 g/mol (preferably with a mass average molar mass up to 10,000 g/mol and more preferably with a mass average molar mass below 20,000 g/mol).

In another form the agrochemical composition is essentially free of surfactants with a mass average molar mass up to 5,000 g/mol (preferably with a mass average molar mass up to 10,000 g/mol and more preferably with a mass average molar mass below 20,000 g/mol).

The term “essentially free” used in the instant application refers to a concentration below 0.5 wt %, preferably below 0.05 wt %, most preferably below 0.01 wt %, each time with regard to the total mass of the agrochemical composition.

The term surfactants refers to surface-active compounds, such as anionic, cationic, non-ionic and amphoteric surfactants, block polymers, polyelectrolytes, and mixtures thereof. Such surfactants can be used as emulsifier, dispersant, solubilizer, wetter, penetration enhancer, protective colloid, or adjuvant. Examples of surfactants are listed in McCutcheon's, Vol. 1: Emulsifiers & Detergents, McCutcheon's Directories, Glen Rock, USA, 2008 (International Ed. or North American Ed.).

The molecular weight of the surfactants is usually below 5,000 g/mol, preferably below 1,000 g/mol, and most preferably below 500 g/mol.

Lignin sulfonates and poly(meth)acrylates usually only fall within the term surfactant if their molecular weight is up to 20,000 g/mol, preferably 10,000 g/mol and most preferably 5,000 g/mol.

Anionic surfactants may be alkali, alkaline earth or ammonium salts of sulfonates, organosulfates, phosphates, carboxylates, and mixtures thereof. Examples of sulfonates are alkylarylsulfonates, diphenylsulfonates, alpha-olefin sulfonates, sulfonates of fatty acids and oils, sulfonates of ethoxylated alkylphenols, sulfonates of alkoxylated arylphenols, sulfonates of condensed naphthalenes, sulfonates of dodecyl- and tridecylbenzenes, sulfonates of naphthalenes and alkylnaphthalenes, sulfosuccinates or sulfosuccinamates. Examples of sulfates are sulfates of fatty acids and oils, of ethoxylated alkylphenols, of alcohols, of ethoxylated alcohols, or of fatty acid esters. Examples of phosphates are phosphate esters. Examples of carboxylates are alkyl carboxylates, and carboxylated alcohol or alkylphenol ethoxylates.

Nonionic surfactants may be alkoxylates, N-substituted fatty acid amides, amine oxides, esters, sugar-based surfactants, polymeric surfactants, and mixtures thereof. Examples of alkoxylates are compounds such as alcohols, alkylphenols, amines, amides, arylphenols, fatty acids or fatty acid esters which have been alkoxylated with 1 to 50 equivalents. Ethylene oxide and/or propylene oxide may be employed for the alkoxylation, preferably ethylene oxide. Examples of N-substituted fatty acid amides are fatty acid glucamides or fatty acid alkanolamides. Examples of esters are fatty acid esters, glycerol esters or monoglycerides. Examples of sugar-based surfactants are sorbitans, ethoxylated sorbitans, sucrose and glucose esters or alkylpolyglucosides. Examples of polymeric surfactants are homo- or copolymers of vinylpyrrolidone, vinylalcohols, or vinylacetate.

Cationic surfactants may be quaternary surfactants, for example quaternary ammonium compounds with one or two hydrophobic groups, or salts of long-chain primary amines. Suitable amphoteric surfactants are alkylbetains and imidazolines. Suitable block polymers are block polymers of the A-B or A-B-A type comprising blocks of polyethylene oxide and polypropylene oxide, or of the A-B-C type comprising alkanol, polyethylene oxide and polypropylene oxide. Suitable polyelectrolytes are polyacids or polybases. Examples of polyacids are alkali salts. Examples of polybases are polyvinylamines or polyethyleneamines.

Preferably, the term surfactant relates to phenolsulphonic acid or naphthalenesulphonic acid, as well as to their condensation products with formaldehyde, polycondensates (homo- and heteropolymers) of ethylene oxide, propylene oxide and butylene oxide, as well as their condensation products with C₁-C₃₀ fatty alcohols, with C₁-C₃₀ fatty acids or with C₁-C₃₀ fatty amines, substituted phenols (preferably alkylphenols or arylphenols), sulphosuccinic esters, taurine derivatives (preferably alkyl taurates), phosphoric esters of polyethoxylated alcohols or phenols, fatty esters of polyols, and derivatives of the aforementioned compounds containing sulphates, sulphonates, phosphonates and phosphates.

More preferably, the term surfactant relates to phenolsulphonic acid or naphthalenesulphonic acid, as well as to condensation products comprising them (such as formaldehyde condensates), polycondensates (homo- and heteropolymers) of ethylene oxide, propylene oxide and/or butylene oxide, as well as their condensation products with C₁-C₃₀ fatty alcohols, with C₁-C₃₀ fatty acids or with C₁-C₃₀ fatty amines, substituted phenols (preferably alkylphenols or arylphenols) and derivatives of the aforementioned compounds containing sulphates, sulphonates, phosphonates and phosphates.

In one form, the term surfactant relates to phenolsulphonic acid or naphthalenesulphonic acid, as well as to condensation products comprising them.

In another form, the term surfactant relates to C₁-C₁₀-alkyl-C₅-C₁₀-aryl-sulfonates (such as C₁-C₁₀-alkyl naphthalene sulfonate, and C₁-C₁₀-alkyl benzene sulfonate), C₅-C₂₄-alkyl sulfonate (such as sodium dodecyl sulfonate, and sodium laurylsulfonate), polyoxyalkylene ethers of C₅-C₂₄-alcohols or C₅-C₂₄-amines, C₁-C₁₀-alkyl benzoic acid, C₁-C₂₄-alkyl phosphonium acids, or polyoxyalkylene ethers.

In another form, the term surfactant relates to C₁-C₁₀-alkyl naphthalene sulfonates, C₁-C₁₀-alkyl benzene sulfonate, polyoxyalkylene ethers, or C₅-C₂₄-alkyl sulfonates.

In another form term surfactant relates to C₁-C₁₀-alkyl naphthalene sulfonates, C₁-C₁₀-alkyl benzene sulfonates, condensates comprising C₁-C₁₀-alkyl naphthalene sulfonates or C₁-C₁₀-alkyl benzene sulfonates, polyoxyalkylene ethers, polyoxyalkylene ethers of C₅-C₂₄-alcohols or C₅-C₂₄-amines, or C₅-C₂₄-alkyl sulfonates.

In another form, the term surfactant relates to polycondensates (homo- and heteropolymers) of ethylene oxide, propylene oxide and butylene oxide, as well as their condensation products with C₁-C₃₀ fatty alcohols, with C₁-C₃₀ fatty acids or with C₁-C₃₀ fatty amines, substituted phenols (preferably alkylphenols or arylphenols) and derivatives of the aforementioned compounds containing sulphates, sulphonates, phosphonates and phosphates, preferably to polycondensates (homo- and heteropolymers) of ethylene oxide, propylene oxide and butylene oxide, as well as their condensation products with C₁-C₃₀ fatty alcohols, with C₁-C₃₀ fatty acids or with C₁-C₃₀ fatty amines, more preferably to polycondensates (homo- and heteropolymers) of ethylene oxide, propylene oxide and butylene oxide.

Mixtures of the listed surfactants are also comprised by the term surfactant.

In one example, the agrochemical composition contains from 1 to 99 wt % of the solid multisite fungicide, from 1 to 40 wt % of the dispersing agent and up to 3 wt % of the surfactant.

In another example, the agrochemical composition contains from 5 to 95 wt % of the solid multisite fungicide, from 1 to 20 wt % of the dispersing agent and up to 1 wt % of the surfactant.

In yet another example, the agrochemical composition contains from 5 to 95 wt % of the solid multisite fungicide, from 1 to 20 wt % of the dispersing agent, up to 1 wt % of the surfactant and up to 1 wt % of the organic solvent.

In yet another example, the agrochemical composition contains from 5 to 95 wt % of the solid multisite fungicide, from 1 to 10 wt % of the dispersing agent, up to 1 wt % of the surfactant and up to 1 wt % of the organic solvent.

In yet another example, the agrochemical composition contains from 5 to 95 wt % of the solid multisite fungicide, from 2 to 10 wt % of the dispersing agent, up to 0.1 wt % of the surfactant and up to 0.1 wt % of the organic solvents.

The agrochemical composition may contain a multisite fungicide and a dispersing agent, wherein the dispersing agent has a mass average molar mass greater than 10,000 g/mol and is selected from lignin sulfonates and poly(meth)acrylates.

Preferably, the agrochemical composition contains the multisite fungicide, the dispersing agent and up to 3 wt % of a surfactant,

wherein the dispersing agent has a mass average molar mass greater than 10,000 g/mol and is selected from lignin sulfonates and poly(meth)acrylates; and
wherein the surfactant has a mass average molar mass up to 10,000.

More preferably, the agrochemical composition contains the multisite fungicide, the dispersing agent, and up to 1 wt % of the organic surfactant,

wherein the dispersing agent has a mass average molar mass above 20,000 g/mol and is selected from lignin sulfonates and poly(meth)acrylates;
and wherein the surfactant has a mass average molar mass of up to 20,000.

Most preferably, the agrochemical composition contains the multisite fungicide, the dispersing agent, up to 1 wt % of the surfactant and up to 1 wt % of the organic solvent;

wherein the dispersing agent has a mass average molar mass above 20,000 g/mol and is selected from lignin sulfonates and poly(meth)acrylates; and
wherein the surfactant has a mass average molar mass of up to 20,000.

Especially preferably, the agrochemical composition contains the multisite fungicide, the dispersing agent, up to 1 wt % of the surfactant and up to 1 wt % of the organic solvent;

wherein the dispersing agent is a lignin sulfonate and has a mass average molar mass above 20,000 g/mol; and
wherein the surfactant has a mass average molar mass of up to 20,000.

Particularly preferably, the agrochemical composition contains the multisite fungicide, ligninsulfonate, up to 0.1 wt % of the surfactant and up to 0.1 wt % of the organic solvent;

wherein the dispersing agent is a lignin sulfonate and has a mass average molar mass above 20,000 g/mol;
wherein the surfactant has a mass average molar mass up to 20,000 and is selected from polycondensates (homo- and heteropolymers) of ethylene oxide, propylene oxide and butylene oxide, as well as their condensation products with C₁-C₃₀ fatty alcohols, with C₁-C₃₀ fatty acids or with C₁-C₃₀ fatty amines, more preferably to polycondensates (homo- and heteropolymers) of ethylene oxide, propylene oxide and butylene oxide.

Also particularly preferably, the agrochemical composition contains the multisite fungicide, and ligninsulfonate, and is essentially free of organic solvents and surfactants;

wherein the dispersing agent is a lignin sulfonate and has a mass average molar mass above 20,000 g/mol;
wherein the surfactant has a mass average molar mass up to 20,000 and is selected from C₁-C₁₀-alkyl naphthalene sulfonates, C₁-C₁₀-alkyl benzene sulfonates, condensates comprising C₁-C₁₀-alkyl naphthalene sulfonates or C₁-C₁₀-alkyl benzene sulfonates, polyoxyalkylene ethers, or C₅-C₂₄-alkyl sulfonates.

Also particularly preferably, the agrochemical composition contains the multisite fungicide, and ligninsulfonate, and is essentially free of organic solvents and surfactants;

wherein the dispersing agent is a lignin sulfonate and has a mass average molar mass above 20,000 g/mol;
wherein the surfactant has a mass average molar mass up to 20,000 and is selected from phenolsulphonic acid or naphthalenesulphonic acid, as well as to their condensation products with formaldehyde.

The agrochemical composition may further contain thickeners, bactericides, anti-freezing agents, anti-foaming agents, colorants, tackifiers and binders.

Suitable thickeners are polysaccharides (e.g. xanthan gum, carboxymethylcellulose), anorganic clays (organically modified or unmodified), polycarboxylates, and silicates.

Suitable bactericides are bronopol and isothiazolinone derivatives such as alkylisothiazolinones and benzisothiazolinones.

Suitable anti-freezing agents are ethylene glycol, propylene glycol, butylene glycol urea and glycerol.

Suitable anti-foaming agents are silicones.

Suitable colorants (e.g. in red, blue, or green) are pigments of low water solubility and water-soluble dyes. Examples are inorganic colorants (e.g. iron oxide, titan oxide, iron hexacyanoferrate) and organic colorants (e.g. alizarin-, azo- and phthalocyanine colorants).

Suitable tackifiers or binders are biological or synthetic waxes, and cellulose ethers.

The present invention further relates to a method for preparing the agrochemical composition by contacting multisite fungicide and the dispersing agent.

The contacting may be achieved in a known manner, such as described by Mollet and Grubemann, Wiley VCH, Weinheim, 2001; or Knowles, New developments in crop protection formulation, Agrow Reports DS243, T&F Informa, London, 2005. Usually, the contacting can be achieved by mixing, grinding or by use of an extruder.

The method for preparing the agrochemical composition may further comprise heating of the agrochemical composition to a temperature from 40 to 150° C., preferably from 50 to 120° C., and most preferably from 60 to 100° C.

Mixing may be done by the use of a ribbon blender, a V-blender, a continuous processor, a cone screw blender, a screw blender, a double cone blender, a double planetary, a high viscosity mixer, a counter-rotating mixer, a double or a triple shaft mixer, a vacuum mixer, a high-shear-rotor-stator, a paddle mixer, a jet mixer, a drum blender, a banbury mixer, an interim mixer or a planetary mixer.

Grinding may be done to the mixture in typical milling devices, such as ball mills, bead mills, rod mills, semi- and autogenous mills, pebble mills, grinding roll mills, Buhrstone mills, tower mills, hammer mills, planetary mills, vertical-shaft-impactor mills, colloid mills, cone mills, disk mills, edge mills, jet mills, pellet mills, stirred mills, three roll mills, vibratory mills, Wiley mills or similar milling and grinding devices known by the skilled person.

Extrusion is usually performed by use of extruders, which are well known in the art. Examples of extruders are ram extruders, planetary-gear extruders, one screw and twin screw extruders. Typically, the extrusion is accomplished at a pressure (usually taken just before entering into the extrusion grid) from 1 to 80 bars, preferably from 1 to 60 bars, and more preferably from 1 to 40 bars. Typically, the extrusion is accomplished at a temperature from 40 to 150° C., preferably from 50 to 120° C., and more preferably from 60 to 100° C. Said temperature refers to the paste during extrusion. When necessary, the temperature is maintained at the desired value by cooling. An extrusion grid may be used with holes of any shape, preferably of circular shape. The diameter of the holes is usually up to 20 mm, preferably up to 10 mm and more preferably up to 5 mm.

The continuous extrudate may be collected on a moving cylinder or on a conveyor belt. Typically, it is subsequently cut, e.g. with a rotating knife, into shorter sticks before or after cooling, preferably after cooling. In the case of circular holes, the spaghetti-shaped extrudate may be cut into cylindrical shape. In case of polygonal holes (e.g. triangular or rectangular), the extrudate may be cut into corresponding shapes. The resulting pellets might be broken into shorter granules before or after drying, preferably after drying.

The present invention further relates to a method of controlling phytopathogenic fungi, wherein the agrochemical composition is allowed to act on the respective pests, their environment or the crop plants to be protected from the respective pest, on the soil and/or on undesired plants and/or on the crop plants and/or on their environment.

Examples of suitable crop plants are cereals, for example wheat, rye, barley, triticale, oats or rice; beet, for example sugar or fodder beet; pome fruit, stone fruit and soft fruit, for example apples, pears, plums, peaches, almonds, cherries, strawberries, raspberries, currants or gooseberries; legumes, for example beans, lentils, peas, lucerne or soybeans; oil crops, for example oilseed rape, mustard, olives, sunflowers, coconut, cacao, castor beans, oil palm, peanuts or soybeans; cucurbits, for example pumpkins/squash, cucumbers or melons; fiber crops, for example cotton, flax, hemp or jute; citrus fruit, for example oranges, lemons, grapefruit or tangerines; vegetable plants, for example spinach, lettuce, asparagus, cabbages, carrots, onions, tomatoes, potatoes, pumpkin/squash or capsicums; plants of the laurel family, for example avocados, cinnamon or camphor; energy crops and industrial feedstock crops, for example maize, soybeans, wheat, oilseed rape, sugar cane or oil palm; maize; tobacco; nuts; coffee; tea; bananas; wine (dessert grapes and grapes for vinification); hops; grass, for example turf; sweetleaf (Stevia rebaudania); rubber plants and forest plants, for example flowers, shrubs, deciduous trees and coniferous trees, and propagation material, for example seeds, and harvested produce of these plants.

The term crop plants also includes those plants, which have been modified by breeding, mutagenesis or recombinant methods, including the biotechnological agricultural products, which are on the market or in the process of being developed. Genetically modified plants are plants whose genetic material has been modified in a manner, which does not occur under natural conditions by hybridizing, mutations or natural recombination (i.e. recombination of the genetic material). Here, one or more genes will, as a rule, be integrated into the genetic material of the plant in order to improve the plant's properties. Such recombinant modifications also comprise posttranslational modifications of proteins, oligo- or polypeptides, for example by means of glycosylation or binding polymers such as, for example, prenylated, acetylated or farnesylated residues or PEG residues.

The user applies the agrochemical composition according to the invention usually from a pre-dosage device, a knapsack sprayer, a spray tank, a spray plane, or an irrigation system. Usually, the agrochemical composition is made up with water, buffer, and/or further auxiliaries to the desired application concentration and the ready-to-use spray liquor or the agrochemical composition according to the invention is thus obtained. Usually, 20 to 2000 liters, preferably 50 to 400 liters, of the ready-to-use spray liquor are applied per hectare of agricultural useful area.

The present invention further relates to a use of the dispersing agent for attenuating the phytotoxicity of a multisite fungicide in agrochemical compositions.

According to one embodiment, individual components of the agrochemical composition according to the invention such as parts of a kit or parts of a binary or ternary mixture may be mixed by the user himself in a spray tank and further auxiliaries may be added, if appropriate.

In a further embodiment, either individual components of the composition according to the invention or partially premixed components, may be mixed by the user in a spray tank and further auxiliaries and additives may be added, if appropriate.

In a further embodiment, either individual components of the composition according to the invention or partially premixed components, can be applied jointly (e.g. after tank mix) or consecutively.

Finally, the invention relates to seed containing the agrochemical composition.

Solutions for seed treatment (LS), flowable concentrates (FS), powders for dry treatment (DS), water-dispersible powders for slurry treatment (WS), water-soluble powders (SS), gels (GF), suspensions (SC), water-dispensable granules (WG) or wettable powders (WP) are usually employed for the purposes of treatment of plant propagation materials, particularly seeds. The compositions in question give, after two-to-tenfold dilution, active substance concentrations of from 0.01 to 60% by weight, preferably from 0.1 to 40% by weight, in the ready-to-use preparations. Application can be carried out before or during sowing. Methods for applying the agrochemical composition on to plant propagation material, especially seeds include dressing, coating, pelleting, dusting, soaking and in-furrow application methods of the propagation material. Preferably, the agrochemical compositions is applied on to the plant propagation material by a method such that germination is not induced, e. g. by seed dressing, pelleting, coating and dusting.

When employed in plant protection, the amounts of active substances applied are, depending on the kind of effect desired, from 0.001 to 10 kg per ha, preferably from 0.005 to 5 kg per ha, more preferably from 0.05 to 2 kg per ha, and in particular from 0.1 to 2 kg per ha.

In treatment of plant propagation materials such as seeds, e. g. by dusting, coating or drenching seed, amounts of active substance of from 0.1 to 5000 g, preferably from 1 to 1000 g, more preferably from 1 to 100 g and most preferably from 5 to 100 g, per 100 kilogram of plant propagation material (preferably seeds) are generally required.

When used in the protection of materials or stored products, the amount of active substance applied depends on the kind of application area and on the desired effect. Amounts customarily applied in the protection of materials are 0.001 g to 2 kg, preferably 0.005 g to 1 kg, of active substance per cubic meter of treated material.

The advantage of the agrochemical composition according to the invention the reduced phytotoxicity of the agrochemical composition as well as the reduced uptake of multisite fungicides into the crop plant.

### EXAMPLES

Dispersing Agent: Ammonium lignin sulfonate, pH 5 in 10 wt % solution, molecular weight distribution within range from 20,000 to 50,000 g/mol.
Surfactant A Block polymer based on polymerized propylene oxide and ethylene oxide, solidification temperature 44° C. (according to DIN/ISO 2207)
Surfactant B Solid benzenesulfonic acid-formaldehyde-phenol-urea polymer, sodium salt, pH 7, solubility in water at 20° C. above 100 g/l
Surfactant C Sodium dodecyl sulfate, sodium salt
Surfactant D Solid sodium salt of naphthalene sulfonate condensate
Antifoam A Polydimethylsiloxane, emulsion in water, 33% solids content.
Antifoam B Mixture of polydimethyl siloxane oil and silica, milky white liquid, dry matter content 100%
Biocide: Aqueous mix of 2-methyl-4-isothiazolin-3-one and 1,2-benzisothiazolin-3-one.
Thickener: Xanthan Gum.
Fungicide A: Dithianone
Fungicide B: N,N′-dimethyl-1,4-dithiin-2,3,5,6-tetracarboxylic acid diimide (as prepared in U.S. Pat. No. 3,364,229)
Fungicide C: 11-ethyl-10,12-dioxo-2,5,8-trithia-4,11-diazatricyclo[7.3.0.0^{3,7}]dodeca-1(9),3,6-triene-6-carbonitrile (as prepared in WO2014/086601)

### Example-1

Water, Fungicide A, Dispersing Agent, ammonium sulfate and China Clay were mixed. This mixture was wet-milled in an IKA Tube Drive bead mill at 4000 rpm for 14 hours, yielding a uniform aqueous suspension AS1 with a particle size around 2 μm.

For preparation of a comparative formulation, water, Fungicide A, Surfactant A, Surfactant B, and Antifoam A were mixed. This mixture was subsequently wet-milled in an IKA Tube Drive bead mill at 4000 rpm for 14 hours, yielding a uniform suspension with a particle size around 2 μm. Propylene glycol, Biocide, Thickener were added and mixed, resulting in a uniform suspension C-AS1. The final concentration of the components is given in Table 1.

TABLE 1
composition of AS1 and C-AS1; concentrations in [g/l]

| Ingredient | AS1 | C-AS1 |
|---|---|---|
| Fungicide A | 400 | 100 |
| Propylene glycol | — | 70 |
| Biocide | — | 2 |
| Ammonium sulfate | 45 | — |
| Dispersing Agent | 85 | — |
| China Clay | 40 | — |
| Surfactant A | — | 30 |
| Surfactant B | — | 20 |
| Thickener | — | 3 |
| Antifoam | — | 5 |
| Water (deionized) | to 1 liter | to 1 liter |

### Example-2

An aqueous suspension AS2 was prepared as described for the aqueous suspensions AS1 in Example-1, with the difference that Fungicide B was used instead of Fungicide A. For preparation of the comparative formulations C1-AS2, C2-AS2, and C3-AS2, water, Fungicide B, Surfactant A and/or Surfactant B and/or Surfactant C and/or Surfactant D and/or Surfactant E and/or Surfactant F, and Antifoam A and/or Antifoam B were mixed. This mixture was subsequently wet-milled in an IKA Tube Drive bead mill at 4000 rpm for 14 hours, yielding a uniform suspension with a particle size around 2 μm. Propylene glycol, Biocide, Thickener A and/or Thickener B were added and mixed, resulting in a uniform suspensions. The final concentrations of the components are given in Table 2.

TABLE 2
composition of AS2, C1-AS2, C2-AS2, and C3-AS2;
concentrations in [g/l]

| Ingredient | AS2 | C1-AS2 | C2-AS2 |
|---|---|---|---|
| Fungicide B | 400 | 100 | 500 |
| Propylene glycol | — | 70 | 100 |
| Biocide | — | 2 | 1.78 |
| Ammonium sulfate | 45 | — | — |
| Dispersing Agent | 85 | — | — |
| China Clay | 40 | — | — |
| Surfactant A | — | 30 | — |
| Surfactant B | — | 20 | — |
| Surfactant C | — | — | 2.37 |
| Surfactant D | — | — | 17.8 |
| Thickener | — | 3 | 1.9 |
| Antifoam A | — | 5 | — |
| Antifoam B | — | — | 1.2 |
| Water (deionized) | to 1 liter | to 1 liter | to 1 liter |

### Example-3

An aqueous suspension AS3 was prepared as described for the aqueous suspension AS1 in Example-1, with the difference that Fungicide C was used instead of Fungicide A. For preparation of the comparative formulations C₁-AS3, C₂-AS3, and C₃-AS3, water, Fungicide C, Surfactant A and/or Surfactant B and/or Surfactant C and/or Surfactant D and/or Surfactant E and/or Surfactant F, and Antifoam A and/or Antifoam B were mixed. This mixture was subsequently wet-milled in an IKA Tube Drive bead mill at 4000 rpm for 14 hours, yielding a uniform suspension with a particle size around 2 μm. Propylene glycol, Biocide, Thickener A and/or Thickener B were added and mixed, resulting in a uniform suspensions. The final concentrations of the components are given in Table 3.

TABLE 3
composition of AS3, C1-AS3, C2-AS3, and C3-AS3;
concentrations in [g/l]

| Ingredient | AS3 | C1-AS3 | C2-AS3 |
|---|---|---|---|
| Fungicide C | 400 | 100 | 500 |
| Propylene glycol | — | 70 | 100 |
| Biocide | — | 2 | 1.78 |
| Ammonium sulfate | 45 | — | — |
| Dispersing Agent | 85 | — | — |
| China Clay | 40 | — | — |
| Surfactant A | — | 30 | — |
| Surfactant B | — | 20 | — |
| Surfactant C | — | — | 2.37 |
| Surfactant D | — | — | 17.8 |
| Thickener | — | 3 | 1.9 |
| Antifoam A | — | 5 | — |
| Antifoam B | — | — | 1.2 |
| Water (deionized) | to 1 liter | to 1 liter | to 1 liter |

### Example-4

Water-dispersible granulates WG1 containing Fungicide A, WG2 containing Fungicide B, and WG3 containing Fungicide C were prepared by mixing the respective pesticide, the Dispersing Agent, ammonium sulfate, and china clay in a ribbon blender followed by the addition tap water to a final mass concentration of 22-24 wt % and thorough mixing in a kneader to a pasty mass. Subsequently, the mass was extruded through a circular hole of 1 mm diameter and the extrudate is dried and broken in a fluidized bed dryer with a maximum inlet air temperature of 85° C. and a maximum product temperature of 50° C. The residual water content after drying was less than 1.4 wt %. The resulting granulate was finally sieved by 0.7 and 2.0 mm sieves and the fraction between was defined as the final water-dispersible granulates WG1, WG2, and WG3. The final concentrations of the components are given in Table 4.

TABLE 4
composition of WG1, WG2, and WG3; concentrations in wt %

| Formulation | WG1 | WG2 | WG3 |
|---|---|---|---|
| Fungicide A | 70 | — | — |
| Fungicide B | — | 70 | — |
| Fungicide C | — | — | 70 |
| Ammonium sulfate | 8 | 8 | 8 |
| Dispersing Agent | 15 | 15 | 15 |
| China clay | to 100 | to 100 | to 100 |

### Example-5

Grape-vine plants were grown in plastic boxes under a netted tunnel that simulated field conditions. Three year old grape-vine plants of the cultivar Kerner were used. Each plant was sprayed on two applications by one composition as described in Examples 1 to 4. The water-dispersible granules were mixed with water prior to the application, resulting in homogeneous suspensions. The first application took place as the plants were in the growth stage (77-78) according to the BBCH identification. The second application took place 7 days later. The compositions were sprayed with a manual backpack sprayer with an application pressure of 3.2 bar and a spraying volume of 500 litters of water per hectare. The dose rate of the fungicides was 1000 g active ingredient per hectare. The evaluation of the phytotoxic symptoms was performed 8 days after the second application as percentage of leaf damage in treated plants. The results were summarized as mean values of three trials for each composition in Table 5.

TABLE 5
phytotoxicity of multisite fungicides on grape-vine plants in % of leaf damage.

| Ingredient | AS1 | C-AS1 | AS2 | C1-AS2 | C2-AS2 | AS3 | C1-AS3 | C2-AS3 |
|---|---|---|---|---|---|---|---|---|
| Phytotoxicity | 20 | 28 | 21 | 32 | 48 | 21 | 46 | 40 |

| Ingredient | WG1 | WG2 | WG3 |
|---|---|---|---|
| Phytotoxicity | 6 | 18 | 12 |

The results demonstrated a decreased phytotoxicity of aqueous suspensions AS1, AS2, and AS3, as well as a decreased phytotoxicity of the water-dispersed compositions WG1, WG2, and WG3 formulations, when compared with the comparative aqueous suspensions comprising the same multisite fungicides.

1. Agrochemical composition comprising a solid multisite fungicide and a dispersing agent,
wherein the dispersing agent has a mass average molar mass greater than 5,000 g/mol and is selected from lignin sulfonates and poly(meth)acrylates;
wherein the multisite fungicide is selected from dithiines; and
wherein the agrochemical composition comprises up to 1 wt % of a surfactant with a mass average molar mass of up to 5,000 g/mol.

2. The agrochemical composition of claim 1, wherein the dispersing agent has a melting temperature above 60° C.

3. The agrochemical composition according to claim 1, wherein the agrochemical composition comprises up to 20 wt % of the dispersing agent.

4. The agrochemical composition according to claim 1, wherein the dispersing agent has a mass average molar mass above 20,000 g/mol.

5. The agrochemical composition according to claim 1, wherein the dispersing agent is a lignin sulfonate.

6. The agrochemical composition according to claim 1, wherein the agrochemical composition comprises up to 0.1 wt % of the surfactant with a mass average molar mass up to 5,000 g/mol.

7. The agrochemical composition according to claim 6, wherein the surfactant is selected from the group consisting of C₁-C₁₀-alkyl naphthalene sulfonates, C₁-C₁₀-alkyl benzene sulfonates, condensates comprising C₁-C₁₀-alkyl naphthalene sulfonates, condensates comprising C₁-C₁₀-alkyl benzene sulfonates, polyoxyalkylene ethers, polyoxyalkylene ethers of C₅-C₂₄-alcohols, polvoxyalkylene ethers of C₅-C₂₄-amines, C₅-C₂₄-alkyl sulfonates, and mixtures thereof.

8. The agrochemical composition according to claim 1, wherein the agrochemical composition comprises less than 1 wt % of an organic solvent.

9. The agrochemical composition according to claim 1, wherein the solid multisite fungicide has a melting temperature above 40° C.

10. The agrochemical composition according to claim 1, wherein the agrochemical composition is selected from the group consisting of suspensions, water-dispersible granulates, and wettable powders.

11. The agrochemical composition according to claim 1, wherein a surface retention after one day of cultivation is at least 90:10.

12. A method for preparing an agrochemical composition comprising contacting a solid multisite fungicide selected from dithiines and a dispersing agent having a mass average molar mass greater than 5,000 g/mol and selected from the group consisting of lignin sulfonates and poly(meth)acrylates.

13. A method of controlling phytopathogenic fungi, the method comprising applying an agrochemical composition to at least one of the respective phytopathogenic fungi and an environment of the phytopathogenic fungi, crop plants to be protected from the phytopathogenic fungi soil, and an environment of the crop plants, the agrochemical composition including up to 1 wt % of a surfactant with a mass average molar mass of up to 5,000 g/mol, a solid multisite fungicide selected from dithiines, and a dispersing agent having a mass average molar mass greater than 5,000 g/mol and selected from the group consisting of lignin sulfonates and poly(meth)acrylates.

14. (canceled)

15. Seed comprising:
an agrochemical composition comprising:
up to 1 wt % of a surfactant with a mass average molar mass of up to 5,000 g/mol;
a solid multisite fungicide selected from dithiines; and
a dispersing agent with a mass average molar mass greater than 5,000 g/mol and selected from the group consisting of lignin sulfonates and poly(meth)acrylates.
